(19) United States
(12) Patent Application Publication
(10) Pub. No.: US 2004/0240356 A1
(43) Pub. Date: Dec. 2, 2004

(54) Method, system and program for authenticating recording medium, and computer readable recording medium

(76) Inventors: Eiji Noda, Kanagawa-ken (JP); Yuuji Kitamura, Kanagawa-ken (JP); Takeshi Watanabe, Kanagawa-ken (JP)

Correspondence Address: DICKSTEIN SHAPIRO MORIN & OSHINSKY LLP, 2101 L STREET NW, WASHINGTON, DC, 20037-1526, US

(21) Appl. No.: 10/808,273

(22) Filed: Mar. 25, 2004

(30) Foreign Application Priority Data
Mar. 25, 2003 (JP) 2003-083012
Sep. 19, 2003 (JP) 2003-328640
Jun. 23, 2003 (JP) 2003-177822

(51) Int. Cl. G11B 5/09

(52) U.S. Cl. 369/53.21; 369/47.22

(57) ABSTRACT

A disk authentication method, system, program, and a computer readable recording medium containing the program are disclosed. A main controller of a host computer executes a data acquisition step for acquiring, from an optical disk, unique data that is recorded on an information track on the optical disk in accordance with a predetermined rule and an authentication step for authenticating the optical disk based on the unique data acquired in the data acquisition step. The disk authentication method thus prevents data illegally copied onto the optical disk from being used.

This application claims priority to Japanese patent applications No. 2003-083012 filed on Mar. 25, 2003, No. 2003-328640 filed on Sep. 19, 2003, and No. 2003-177822 filed on Jun. 23, 2003 in the Japan Patent Office, the entire contents of which are incorporated by reference herein.

### FIELD OF THE INVENTION

The present invention relates to a method, system, and computer program for authenticating a recording medium as to whether data recorded onto the recording medium such as an optical disk is illegally copied. The present invention also relates to a computer readable recording medium recording the computer program.

### BACKGROUND OF THE INVENTION

Optical disks (recording media), such as CDs and CD-ROMs, for recording information are in widespread use. The optical disks are read-only optical disks, and are produced in bulk in plants.

The read-only optical disk is manufactured in the following way. A train of pits formed on an original master disk is transferred to a stamper using a mastering apparatus, a disk is molded from the stamper, and the disk is then coated with a reflective layer, a protective layer, etc. Time information (header address, namely, physical address) is recorded in the form of pits together with digital data on the optical disk. The digital data is replayed in accordance with the time information recorded in the form of the pits.

CD-recordable (CD-R) disks and CD-rewritable (CD-RW) disks are also in widespread use.

These optical disks have grooves that extend over the entire surface thereof and have time information recorded therein. The disk having the grooves formed thereon is coated with a recording layer (such as a colorant in the CD-R disk and a phase change film in the CD-RW disk), a reflective layer, a protective layer, etc. Pits are written on the disk using a CD-R/RW writer so that the pits are synchronized with the recorded time information. The header address (time information) and data are thus recorded.

In a CD format, a group of a lead-in area (LIA), a lead-out area (LOA), a program area (PA) interposed between the LIA and the LOA is referred to as a session. A disk having a plurality of sessions is called a multi-session disk.

Some types of disks have a data structure in which prepits are formed in a portion of a replay-only area (read-only area). CD-R disks and CD-RW disks, having such a structure, are called hybrid disks.

Information is stored in an application specific format in the optical disks, such as the CD-R disk and the CD-RW disk. For example, music is recorded in a CD format, and data is recorded in the ISO 9660 format.

When the ISO 9660 format is used, data recording is performed on a session-by-session basis. The lead-in area and the lead-out area must also be recorded. Even to record a small file, an overhead of 10 Mbytes or more is involved.

A format called universal disk format (UDF) working in a random-access fashion is now available.

The UDF allows data to be recorded by packet. The packet has a size as large as 64 Kbytes (32 blocks). As with the ISO 9660 format, an optical CD-RW disk having data recorded in the UDF is replayable on an information replay device such as a CD-ROM device.

Information recorded in the replay-only optical disk (including a hybrid disk having partially a replay-only area) is digital, and free from collapse through copying.

However, the replay-only optical disks have a drawback that information such as data and application programs recorded on the optical disk is subject to unauthorized copying and unauthorized use.

### SUMMARY OF THE INVENTION

Accordingly, it is an object of the present invention to prevent unauthorized copied data from being used.

The present invention in one aspect relates to a method for authenticating a recording medium, and includes a data acquisition step for acquiring, from the recording medium, unique data that is recorded on an information track on the recording medium in accordance with a predetermined rule, and an authentication step for authenticating the recording medium based on the unique data acquired in the data acquisition step.

Preferably, the predetermined rule is based on a plurality of types of recording methods.

Preferably, the plurality of types of recording methods include an uninterrupted recording method and an incremental recording method.

Preferably, the uninterrupted recording method is a track at once recording method, and the incremental recording method is a packet write recording method.

Preferably, the unique data includes information for identifying the recording method.

Preferably, he unique data includes at least one of data in a track descriptor unit and data in a sub-code control.

The unique data may include data within a runout.

The unique data may include data within a predetermined packet.

The unique data may include data that is recorded in multiple sessions.

The unique data may include data that is recorded in a variable packet.

The present invention in another aspect relates to a method for authenticating a recording medium, and includes data acquisition step for acquiring, from the recording medium, unique data that is recorded in a variable packet on an information track on the recording medium in accordance with a predetermined rule, and an authentication step for authenticating the recording medium based on the unique data, acquired in the data acquisition step.

Preferably, the recording medium has, in a first session, a second track as a dummy track not present in the ISO 9660 file system and wherein the information track comprises an LIA and a PMA.

Preferably, the data includes track information.

Preferably, the track information identifies a recording method of the track.

Preferably, the track information identifies a recording position of the track.

Preferably, the recording medium records data in multiple sessions.

The information track may include a PMA and a second track that is additionally recorded.

The unique data of the second track that is recorded may include a disk ID.

The present invention in yet another aspect relates to a computer program for causing a computer to perform the data acquisition step and the authentication step.

The present invention in a further aspect relates to a computer readable recording medium storing a computer program for causing a computer to perform the data acquisition step and the authentication step.

Preferably, the computer readable recording medium includes a read-only memory area and a read and write memory area, and stores, on the read and write area, a computer program for causing a computer to perform the data acquisition step and the authentication step.

The authentication method of the recording medium, the computer program, and the computer readable recording medium thus prevent data illegally copied onto the recording medium such as an optical disk from being used.

The present invention in a further aspect relates to an optical disk drive system which includes a memory and a processor. The memory stores a program, and the processor is configured to execute the program stored in the memory. The program stored in the memory includes an instruction for authenticating a recording medium, including the steps of acquiring and authenticating. The acquiring step acquires, from the recording medium, unique data that is recorded on an information track on the recording medium in accordance with a predetermined rule. The authenticating step authenticates the recording medium based on the unique data acquired in the data acquisition step.

### BRIEF DESCRIPTION OF THE DRAWINGS

A more complete appreciation of the disclosure and many of the attendant advantages thereof will be readily obtained as the same becomes better understood by reference to the following detailed description and the accompanying drawings, wherein:

FIG. 1 is a block diagram illustrating the internal structure of an optical disk device;

FIG. 2 is a block diagram illustrating an optical drive system that executes an authentication process of a recording medium in accordance with one preferred embodiment of the present invention;

FIG. 3 illustrates an example of CD format of the optical device illustrated in FIG. 1;

FIG. 4 illustrates a format within a track of the CD format illustrated in FIG. 3;

FIG. 5 illustrates an internal format of a run-out block, a link block, and run-in block illustrated in FIG. 4;

FIG. 6 illustrates a format within a track descriptor block illustrated in FIG. 4;

FIG. 7 is a flowchart illustrating a process in an optical disk operation in an optical disk system.

FIG. 8 is a flowchart illustrating an authentication process of the optical disk illustrated in FIG. 7;

FIG. 9 is a continuation of the flowchart of FIG. 8;

FIG. 10 is a continuation of the flowchart of FIG. 9;

FIG. 11 is a continuation of the flowchart of FIG. 10;

FIG. 12 is another continuation of the flowchart of FIG. 8;

FIG. 13 is a continuation of the flowchart of FIG. 12;

FIG. 14 is a continuation of the flowchart of FIG. 13;

FIG. 15 illustrates a format of an optical disk having a first session with a first track that is continuously recorded in a copy protective manner;

FIGS. 16A and 16B illustrate a format of an optical disk having a first session with a first track that is continuously recorded in a copy protected manner and a second session with a second track that is continuously recorded in a copy protected manner;

FIG. 17 illustrates a format of an optical disk having a first session with a first track that is continuously recorded in a copy protected manner and with a second track that is continuously recorded in a copy protected manner;

FIG. 18 illustrates a CD format of an optical disk of a sixth preferred embodiment of the present invention;

FIG. 19 is a flowchart illustrating an authentication process of the optical disk of FIG. 18;

FIG. 20 illustrates a return value in response to a read disk information command and the maximum number of tracks obtained from the return value;

FIG. 21 illustrates a return value in response to a read TOC command and track information of PMA acquired using the return value;

FIG. 22 illustrates a return value in response to a read TOC command and track information of TOC acquired using the return value;

FIG. 23 illustrates a CD format of an optical disk in accordance with a seventh preferred embodiment of the present invention;

FIG. 24 is a flowchart of an operation to record user data in a second session of the optical disk of FIG. 23; and

FIG. 25 is a flowchart illustrating an authentication process of the optical disk of FIG. 23.

### DESCRIPTION OF THE PREFERRED EMBODIMENTS

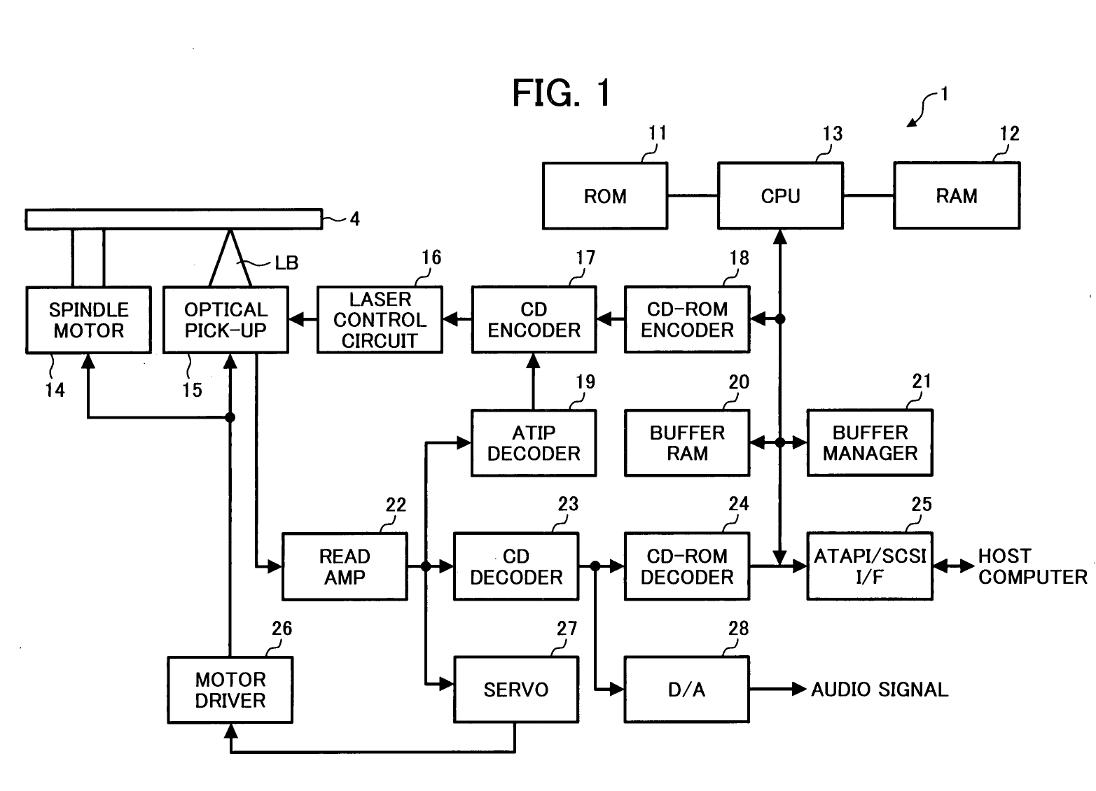

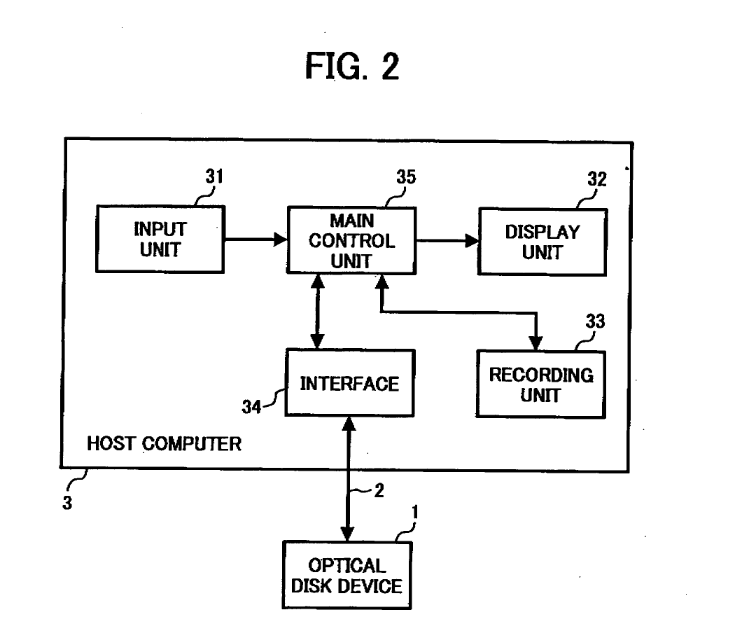

In describing preferred embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner. Referring now to the drawings, wherein like reference numerals designate identical or corresponding parts throughout the several views, particularly to FIGS. 1 and 2, an optical disk device 1 and an exemplary optical disk drive system including the optical disk device 1, according to an embodiment of the present invention, are explained. FIG. 1 is a block diagram illustrating the internal structure of the optical disk device 1 and FIG. 2 is a block diagram of the optical disk drive system that authenticates an optical disk as a recording medium in accordance with an embodiment of the present invention.

Optical disks such as CD-ROM, CD-R, CD-RW, and CD-RAM are used as recording media for recording a large amount of data (information).

CD-R disks, and CD-RW disks are writable (recordable) compact disks (CDs).

The CD-R disks are writable one time only. The CD-R is also referred to CD-Write Once.

The CD-RW (CD-rewritable) is writable for a plurality of times. Optical disks, such as CD-R or CD-RW, are used in an optical disk drive system (information processing system) shown in FIG. 2.

As shown, the optical disk drive system includes a host computer (information processing apparatus) 3, and the optical disk device (optical disk drive) 1 connected to the host computer through a communication cable 2 for data exchange.

The host computer 3 includes a main controller 35, an interface 34, an interface 34, a recording device (hard disk drive) 33, an input unit 31, a display unit 32, etc.

The main controller 35, including a known microcomputer (not shown), and a known main memory (not shown), generally controls the host computer 3.

The interface 34 is a two-way communication interface with the optical disk device 1, and may be a standard interface complying with the ATAPI or SCSI standard.

The interface 34 is connected to an ATAPI/SCSI interface 25 of the optical disk device 1. A communication link between the interfaces is not limited to a wired type using a communication cable (SCSI cable) 2, and may be a wireless type such as an infrared link.

The recording device 33 stores a program written in a code readable by the microcomputer of the main controller 35. When the host computer 3 is powered on, the program is loaded onto a main memory of the main controller 35.

The display unit 32 includes a display (not shown) such as a cathode-ray tube (CRT), a liquid-crystal display (LCD), or a plasma display panel (PDP), and displays various information from the main controller 35.

The input unit 31 includes at least one input medium (not shown) such as a keyboard, a mouse, and a pointing device, and notifies the main controller 35 of various information input by a user. The information from the input medium may be input using a wireless link. For example, a CRT with a touch panel attached thereto is available as an apparatus into which the display unit 32 and the input unit 31 are integrated.

An operating system (OS) is installed in the host computer 3. All devices constituting the host computer 3 are controlled by the OS.

As shown in FIG. 1, the optical disk device 1 includes a spindle motor 14, an optical pickup 15, a motor driver 26, a read amplifier 22, a servo 27, a CD decoder 23, an ATIP decoder 19, a laser control circuit (laser controller) 16, a CD encoder 17, a CD-ROM encoder 18, a buffer RAM 20, a buffer manager 21, a CD-ROM decoder 24, the ATAPI/SCSI interface 25, a D/A converter 28, an ROM 11, a CPU 13, an RAM 12, etc. The optical disk device 1 records information to and replays information from an optical disk 4. As shown, each arrow-headed line connecting blocks shows the direction of data flow.

The ROM 11 stores a control program written in a code readable by the CPU 13. When the optical disk device 1 is powered on, the control program is loaded onto a known main memory, and the CPU 13 controls the operation of each of the above blocks while temporarily storing data and the like required in the control of each block in the RAM 12.

The structure and operation of the optical disk device 1 are discussed below.

The optical disk 4 is driven by the spindle motor 14. The spindle motor 14 is controlled by the motor driver 26 and the servo 27 so that the linear velocity of the spindle motor 14 becomes constant. The linear velocity is controllable in a stepwise manner.

The optical pickup 15 includes elements (not shown) such as a known semiconductor laser light source (LD), an optical system, a focus actuator, a track actuator, a photosensitive device (PD), and a position sensor. The optical pickup 15 directs a laser beam LB to the optical disk 4. The optical pickup 15 is moved in a radial direction across the optical disk 4 by a seek motor. The focus actuator, the track actuator, and the seek motor are controlled by the motor driver 26 and the servo 27 in accordance with a signal from the photosensitive device and the position sensor so that the laser beam LB is directed to a target position on the optical disk 4.

During a read operation, a replay signal obtained from the optical pickup 15 is amplified and binarized by the read amplifier 22, and then input to the CD decoder 23. The binarized data is eight-to-fourteen (EFM) demodulated by the CD decoder 23. The recording data has been EFM modulated. In the EFM modulation, eight bit data is converted into fourteen bit data, to which three link bits are attached. Resulting data has a total of seventeen bits. The link bits are attached so that the average number of “1s” and the average number of “0s” are equalized to each other to suppress DC component. This arrangement controls variations in the slice level of a DC cut replay signal.

The demodulated data is subjected to a deinterleave process and an error correction process. The resulting data is then input to the CD-ROM decoder 24, which further performs an error correction process on the data to heighten data reliability. The data that has error corrected twice is temporarily stored in the buffer RAM 20 by the buffer manager 21. When the data becomes complete as sector data in the buffer RAM 20, the data is transmitted to the host computer 3 through the ATAPI/SCSI interface 25 at a time.

If the data is music, the data output from the CD decoder 23 is input to the D/A converter 28, which in turn outputs the data in the form of an analog audio output signal “Audio”.

During a write operation, the buffer manager 21 temporarily stores data coming in from the host computer 3 in the buffer RAM 20. When a predetermined amount of data from the host computer 3 is stored in the buffer RAM 20, a write operation starts. Before the write operation, a laser beam spot must be directed to a write start point. The write start point is determined by a wobble signal that is engraved beforehand on the optical disk 4 with a track extending in a serpentine fashion.

The wobble signal contain absolute time information called ATIP, and the absolute time information is retrieved by the ATIP decoder 19. A synchronization signal generated by the ATIP decoder 19, input to the CD encoder 17, enables data to be written on the optical disk 4 at a precise position. The data of the buffer RAM 20 is subject to an error code attachment process and an interleave process in the CD-ROM encoder 18 and the CD encoder 17. The resulting data is then recorded onto the optical disk 4 through the laser control circuit 16 and the optical pickup 15.

The EFM modulated data in a bit stream drives the laser at a channel bit rate of 4.3218 Mbps (standard rate). The recording data forms an EFM frame every 588 channel bits. A channel clock refers to a clock having a frequency of the channel bit.

The main controller 35 in the host computer 3 acquires a program that is recorded on an ROM area (a read-only memory area or a replay-only memory area) of the optical disk 4 by the optical disk device 1, and performs an authentication determination process of the optical disk 4 by executing the program.

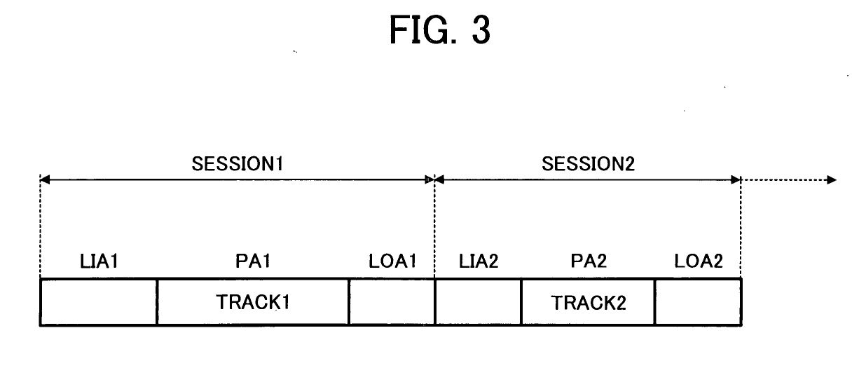

FIG. 3 illustrates an example of a CD format of the optical disk 4 shown in FIG. 1.

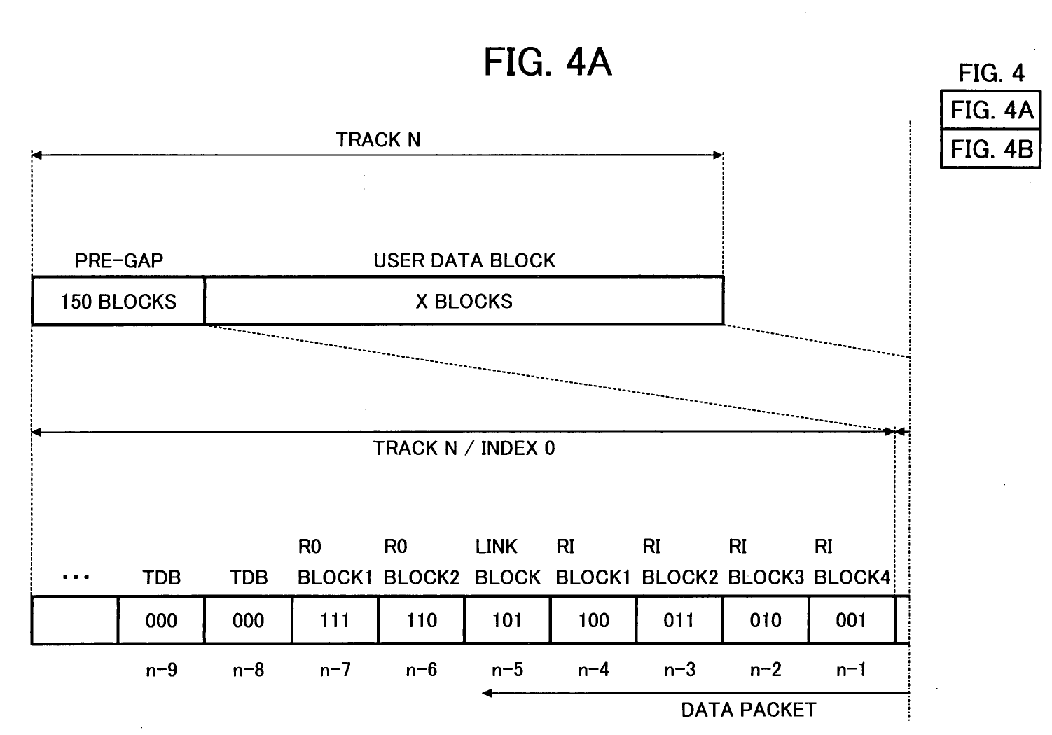

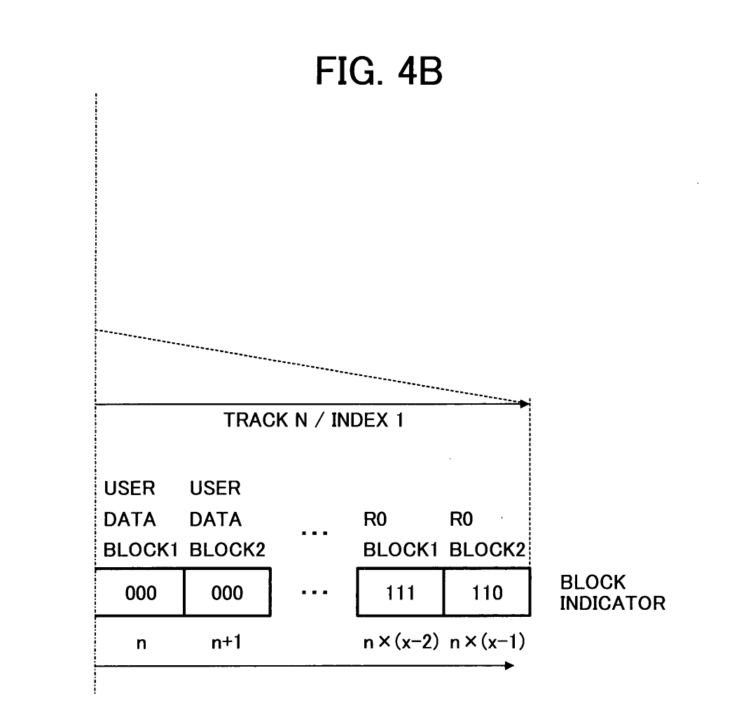

FIG. 4 illustrates an in-track format of the CD format of FIG. 3.

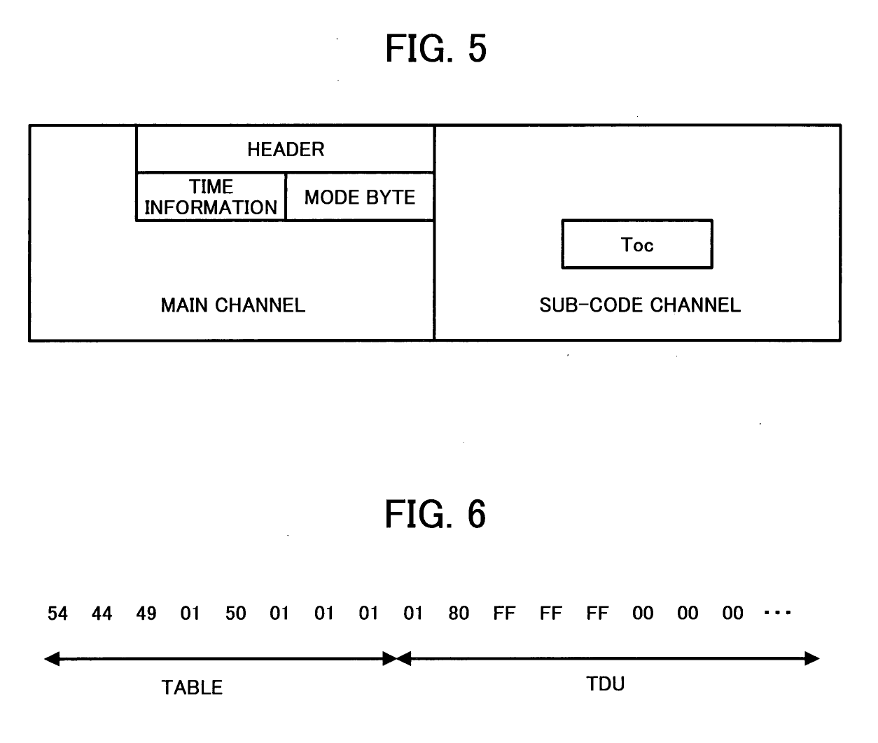

FIG. 5 illustrates the internal format of a runout (RO) block (RO block), a link block, and a run-in (RI) block illustrated in FIG. 4.

FIG. 6 illustrates a format of a track descriptor block of FIG. 4.

As shown in FIG. 3, the optical disk 4 includes a session 1 and a session 2. The session 1 is a read-only memory area, and the session 2 is a random-access memory area. A program of the present invention is stored in the session 1.

Each session includes a lead-in area (LIA), a program area (PA), and a lead-out area (LIA). The PA includes at least one track.

Two types of information recording methods for recording on a per packet basis are available, namely, a fixed packet (FP) recording method for recording data on a fixed size packet basis, and a variable packet (VP) recording method for recording data in a packet size different dependent on the size of data to be recorded.

The PA includes at least one track. As shown in FIG. 4, each track includes at the head portion thereof a pre-gap (of 150 blocks, for example) containing a track descriptor block (TDB), a runout (RO) block, a link block, a run-in (RI) block, etc. The pre-gap is followed by a user data block.

As shown in FIG. 5, the RO block, the link block, and the RI block are distinguished from the user data block by a block indicator recorded in a mode byte of a header of a main channel (block header). Also recorded in the header is time information.

As shown in FIG. 6, an attribute of the track is recorded in a track descriptor unit (TDU) of a user data field of the TDB.

Recorded in the sub-code channel of the PA are a control and ADR representing a type of information on the track in addition to time information representing a relative address within the track and an absolute address within the track.

The control and ADR representing the type of the information on the track are also recorded on a table of contents (TOC) of the LIA.

In the case of data tracks recorded continuously in a copy protective manner, during the write mode, the TDU is “80 (=1000−0000)”, and the control is “4 (=0100)”.

In the case of data tracks recorded continuously in a VP in a copy protective manner, the TDU is “90 (=1001−0000)”, and the control is “5 (=0101).

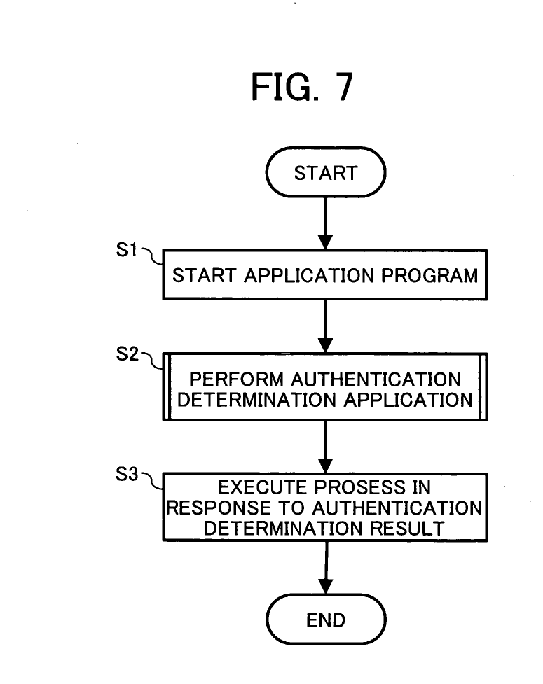

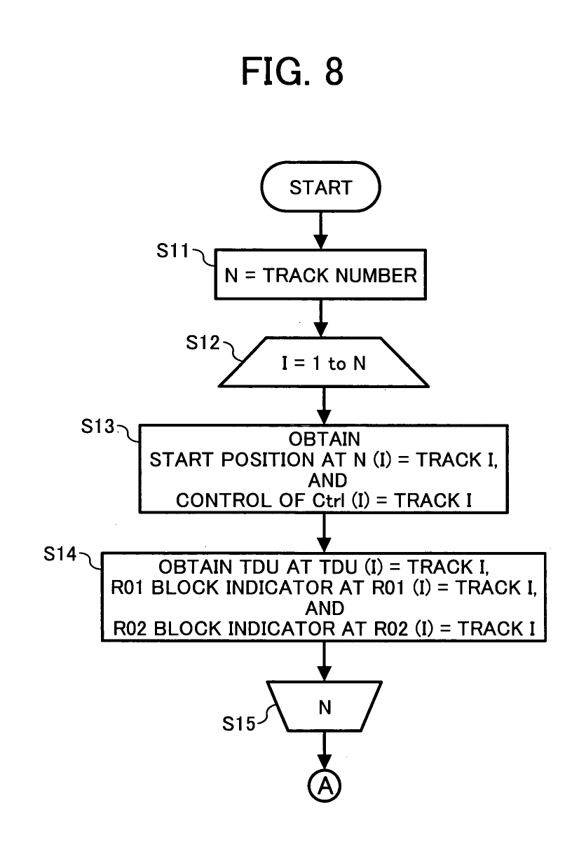

The process of the optical disk system in accordance with the present invention will now be discussed. FIG. 7 is a flowchart of a general process of the optical disk system using the optical disk 4, and FIGS. 8-14 are flowcharts illustrating two exemplary operations of the authentication process of FIG. 7.

In Step S1 of FIG. 7, the optical disk system starts an application program specifically using an optical disk and subsequently checks an authentication of the optical disk 4 used by performing the authentication determination application, in Step S2. Then, in Step S3, the optical disk system performs a responsive process based on the results of the authentication determination application. The process then ends.

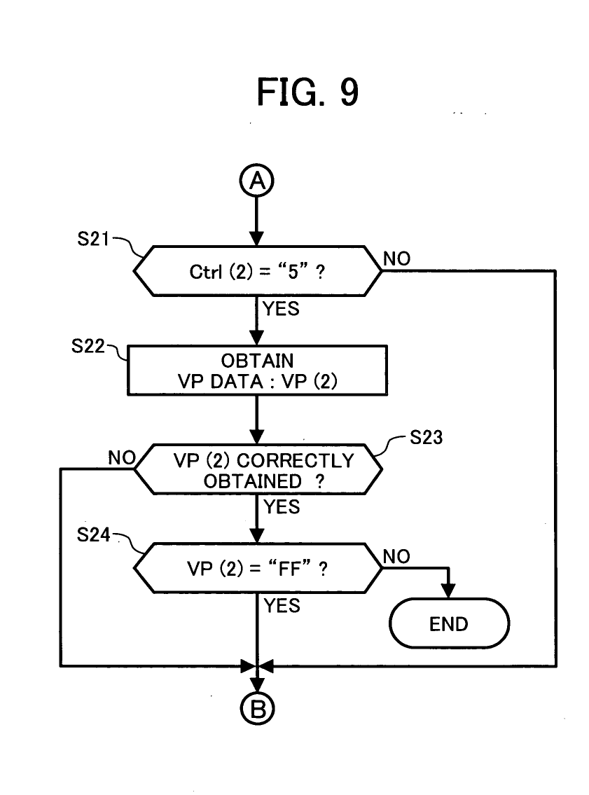

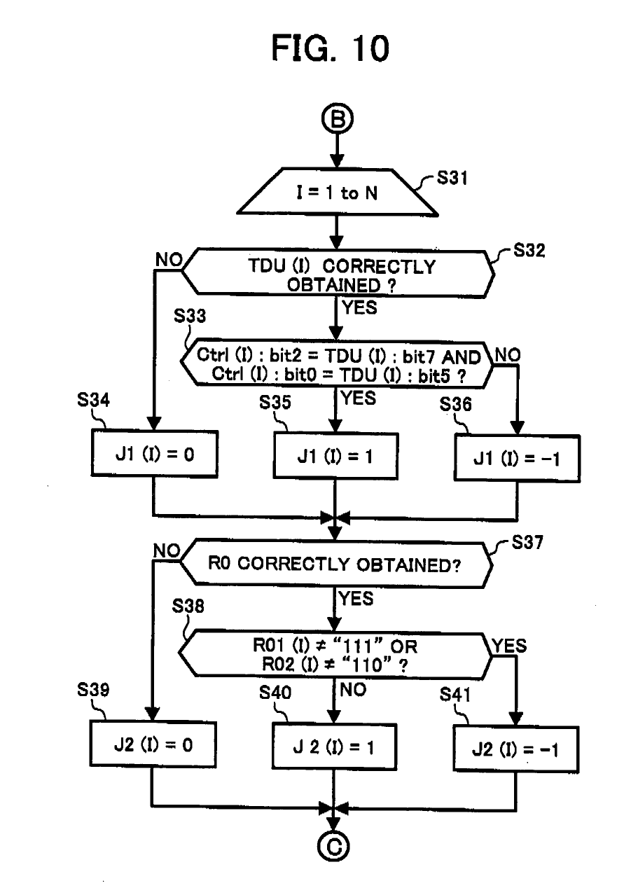

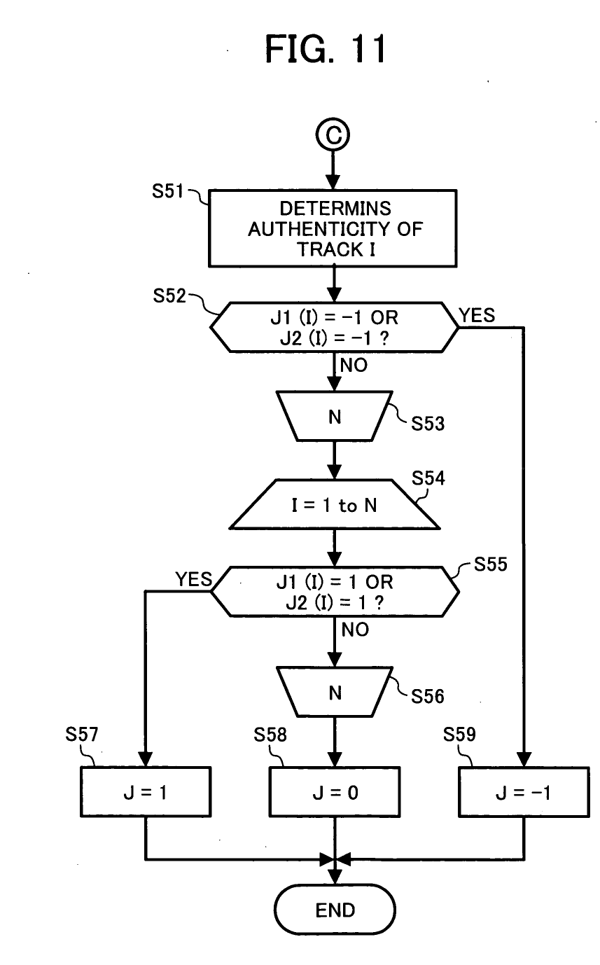

The process illustrated in FIGS. 8-11 is one example of the authentication process in accordance with a first embodiment of the present invention, including a data acquisition step and an authentication determination step to the optical disk 4. The data acquisition step is explained with reference to FIGS. 8 and 9, and the authentication determination step is explained with reference to FIGS. 10 and 11. In this exemplary authentication process, it is assumed that the VP tracks to be checked are the second track only and other tracks are not the VP tracks.

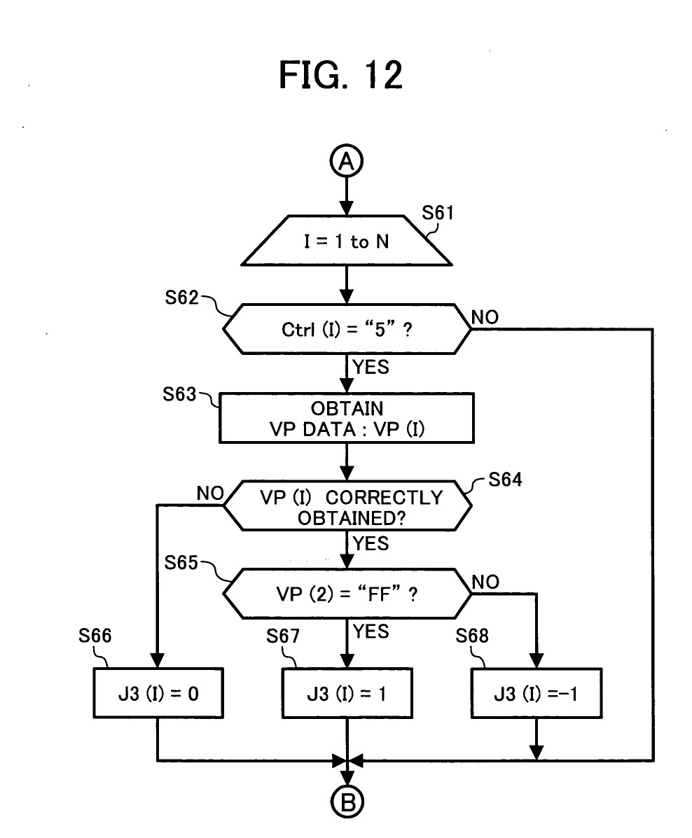

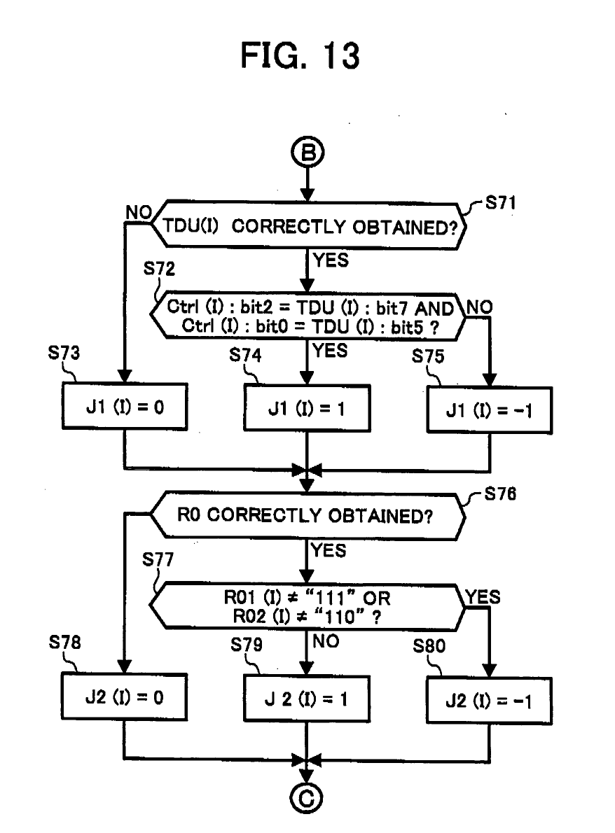

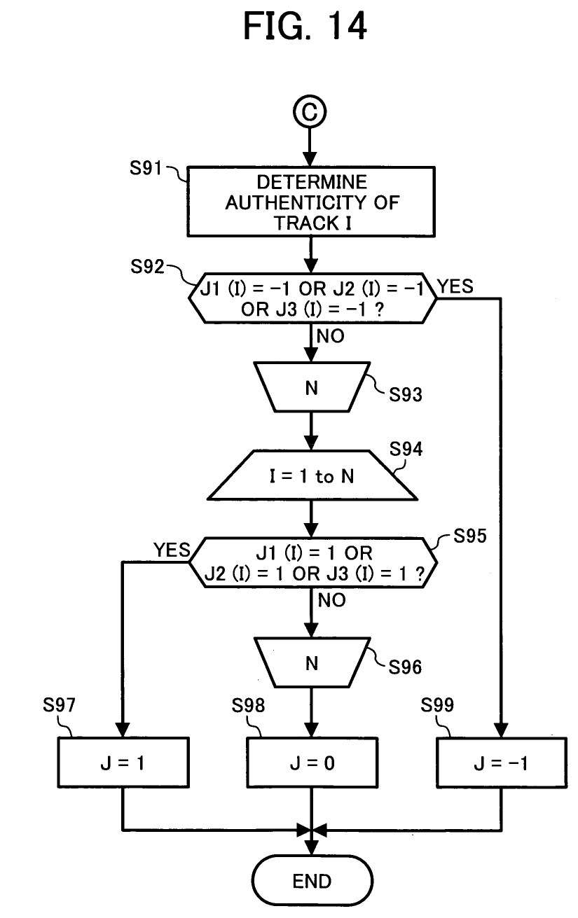

The process illustrated in FIGS. 8 and 12-14 is another example of the authentication process in accordance with a different embodiment of the present invention, wherein a part of the data acquisition step shown in FIG. 8 is commonly used by both authentication processes. The data acquisition step in the second authentication process is explained with reference to FIGS. 8 and 12 and the authentication determination step is explained with reference to FIGS. 13 and 14.

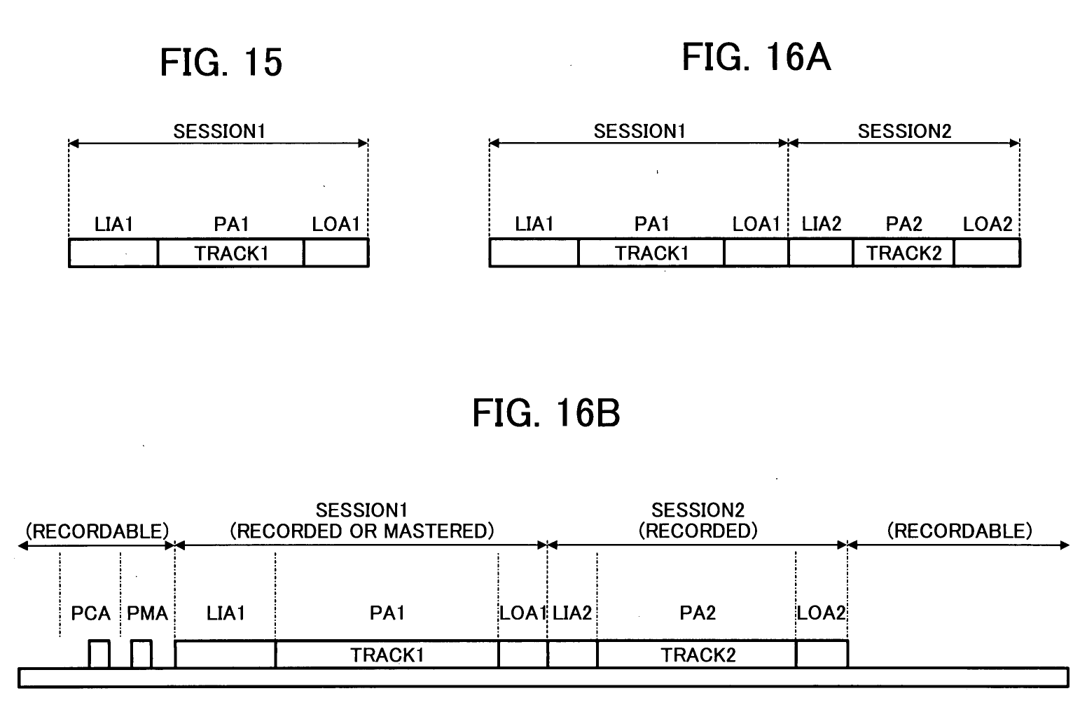

The optical disk 4 has a session1 with a track1 that is continuously recorded in a copy protective manner as shown in FIG. 15. The track of the optical disk 4 has the structure (N=1) shown in FIG. 4. The optical disk 4 has at least two tracks with data recorded in a multi-session. At least one track other than the track1 of the session1 is recorded using the UDF. Data serving the authentication determination purpose is recorded in the UDF track.

An authorized copy determination module performs the authentication determination process including Steps S11-S15 of FIG. 8. In Step S11, the authorized copy determination module sets the track number to N. Step S12 is a start of a process loop and Step S15 is an end of the process loop, in which Steps S13 and S14 are repeated until a condition of Step S12, “I=(1 to N),” is fulfilled. In Step S13, a start address (n) of user data of the track, the length (x) of the user data, and control (Ctrl) are acquired in response to a read TOC command. Then, in Step S14, TDU is acquired from a user field of the TDB at an address (n−8) or smaller in response to a read command and, also, block indicators of RO blocks at addresses (n+x−2) and (n+x−1) are acquired in response to a read command.

Then, it is determined whether the track2 having data recorded in copy protection with VP, in which case Ctrl(2) is 5, is filled with the authentication determination data of repeated “FF,” for example.

In FIG. 9, Step S21 determines whether Ctrl(2) is 5, and subsequently Step S22 acquires VP data of VP(2). After that, Step S23 determines whether VP(2) is correctly acquired and Step S24 determines whether VP(2) is FF. In this process, the operation ends when VP(2) is not FF in Step S24. When Ctrl(2) is not 5 in Step S21, or when VP(2) is not correctly acquired in Step S23 due to a command error, for example, or when VP(2) is FF, the process proceeds to Step S31 of FIG. 10. Step S31 is a start of a process loop from Step S32 to Step S52 of FIG. 11, ended with a process loop end of Step S53. This process loop is repeated until I becomes N, varying from 1.

As described above, TDU is 80 (=1000−0000) and Ctrl is 4 (=0100) in the case of data tracks recorded continuously in the copy protection during the write mode, and TDU is 90 (=1001−0000) and Ctrl is 5 (=0101) in the case of data tracks recorded continuously in the copy protection using VP. In FIG. 10, Step S32 determines whether TDU(I) is correctly acquired, and Step S33 determines whether values of TDU and Ctrl are correct. That is, Ctrl bit2 is checked to be equal to TDU bit7, Ctrl bit0 is checked to be equal to TDU bit5, and Ctrl is checked to be 5. When these values are satisfied, “1” (authentic) is obtained and is entered into a variable J1 in Step S35. When Ctrl bit2 is determined as not being equal to TDU bit7, or when Ctrl bit0 is determined as not being equal to TDU bit5, or when Ctrl is determined as not being 5, “−1” (false) is obtained and is entered into the variable J1 in Step S36. When TDU is determined as not being correctly obtained due to a command error, for example, in Step S32, “0” is entered into the variable J1 in Step S34.

Further in FIG. 10, it is noted that RO1 is “111” and RO2 is “110” in an authorized disk. When one of the RO1 and RO2 fails to agree with the respective values, “−1” (false) is returned. If both the RO1 and the RO2 agree with the respective values, “1” (authentic) is returned. In a case of a command error, “0” is returned. More specifically, Step S37 determines whether RO is correctly acquired and Step S38 determines whether RO1 has an inequality with “111,” or whether RO2 has an inequality with “110.” Thus, when RO is correctly acquired in Step S37 and when RO1 is equal to 111 and RO2 is equal to 110 in Step S38, “1” (authentic) is acquired and is entered into a variable J2 in Step S40. When RO is correctly acquired in Step S37 and when RO1 is equal to 111 and RO2 is equal to 110 in Step S38, “−1” (false) is acquired and is entered into the variable J2 in Step S41. When RO is determined as not being correctly obtained due to a command error, for example, in Step S37, “0” is entered into the variable J2 in Step S39.

In response to an authentication determination command from an application program, the authorized copy determination module performs the above process of FIGS. 8-10, and provides J1 and J2 as return values. The application program authenticates the optical disk referring to the return values based on the following table, and determines a subsequent process depending on security level.

| | TABLE | | |
|---|---|---|---|
| | J1 | | |
| J2 | 1 | 0 | −1 |
| 1 | 1 | 1 | −1 |
| 0 | 1 | 0 | −1 |
| −1 | −1 | −1 | −1 |

For example, when the authenticity determination result of the optical disk based on the values of J1 and J2 is “1” or “0” according to TABLE above, the optical disk is determined as having authorized copied data or the optical disk is determined as having the original data recorded, and an application is performed as a process to be performed on an authorized optical disk.

If the authentication determination result based on the values of J1 and J2 is “−1” according to TABLE above, the optical disk is determined as having unauthorized copied data, and execution of an application is inhibited as a process to be performed on an unauthorized disk.

This determination process is achieved by Steps S51-S59 of FIG. 11. That is, Step S51 determines the authenticity of the track(I) based on the resultant values of J1 and J2, as described above. Step S52 determines whether J1(I) is “−1” or J2(I) is “−1.” When one of J1(I) and J2(I) is “−1” in Step S52, “−1” is entered into a variable J in Step S59. When neither one of J1(I) and J2(I) is “−1” in Step S52, a process loop of Step 55 starting with Step S54 and ending with Step S56 is executed. Step S55 determines whether any one of J1(I) and J2(I) is “1.”

When one of J1(I) and J2(I) is “1” in Step S55, “1” is entered into the variable J in Step S57. When neither one of J1(I) and J2(I) is “1” in Step S55, “0” is entered into the variable J in Step S58.

In an optical disk authentication process of a second preferred embodiment, the optical disk 4 includes a session1 having a track1 with data continuously recorded in a copy protective manner thereon, and a session2 having a track2 with data continuously recorded in a copy protective manner thereon as shown in FIG. 16A. The track has the structure shown in FIG. 4 (N=1, 2).

The optical disk 4 stores a program for causing a computer to execute at least one of two steps. One step is to determine whether the value of the TDU of the pre-gap of each track matches one of the control value of the sub-code of each track and the control value of track information of the TOC, and the other step is to authenticate the optical disk based on whether the run-out value of the link portion of each track or each packet is normal.

An authorized copy determination module for performing an authentication determination process executes the following steps A-E (not shown).

A. Start addresses of the user data of the track1 and the track2, the lengths of user data (x and y), and control (Ctrl1 and Ctrl2) are acquired in response to a read TOC command.

B. TDU1 is acquired from a user data field of the TDB at an address (n−8) or less in the track1, and TDU2 is acquired from a user data field of the TDB at an address (m−8) or less in the track2 in response to a read command.

C. In response to a read command, RO block indicators RO11 and RO12 of the RO blocks in addresses at (n+x−2) and (n+x−1) in the track1 are acquired and RO block indicators RO21 and RO22 of the RO blocks in addresses at (m+y−2) and (m+y−1) in the track2 are acquired.

D. In an authorized disk, the Ctrl1 and Ctrl2 are “4 (=0100)”, and the TDU1 and TDU2 are “80 (=1000-0000).” If Ctrl1 bit2 is equal to TDU1 bit7, Ctrl1 bit0 is equal to TDU1 bit5, and Ctrl1 is “5”, “1” (authentic) is obtained. If Ctrl1 bit2 is not equal to TDU1 bit7, Ctrl1 bit0 is not equal to TDU1 bit5, or Ctrl 1 is not “5”, “−1” (false) is obtained. In the case of a command error, “0” is entered for a variable J11.

If Ctrl2 bit2 is equal to TDU2 bit7, Ctrl2 bit0 is equal to TDU2 bit5, and Ctrl2 is “5”, “1” (authentic) is obtained. If Ctrl2 bit2 is not equal to TDU2 bit7, Ctrl2 bit0 is not equal to TDU2 bit5, or Ctrl2 is not “5”, “−1” (false) is obtained. In the case of a command error, “0” is entered for a variable J12.

If one of J11 and J12 is “−1”, “−1” (false) is obtained. If both J11 and J12 are “1”, “1” (authentic) is obtained. In other cases, “0” is entered for the variable J1.

E. In an authorized disk, RO11 and RO21 are “111”, and RO12 and RO22 are “110.” If any of RO11, RO12, RO21, and RO22 fails to agree with the respective value, “−1” (false) is obtained. If all RO11, RO12, RO21, and RO22 agree with the respective values thereof, “1” (authentic) is obtained. In the case of a command error, “0” is entered for the variable J2.

In response to an authentication determination command from an application program, the authorized copy determination module performs the above steps A-E, and provides J1 and J2 as return values. The application program authenticates the optical disk referring to the return values based on the table, and determines a subsequent process depending on security level.

For example, when the authentication determination result of the optical disk based on the values of J1 and J2 is “1” or “0” according to TABLE above, the optical disk is determined as having authorized copied data or the optical disk is determined as having the original data recorded, and an application is performed as a process to be performed on an authorized optical disk.

When the authentication determination result based on the values of J1 and J2 is “−1” according to TABLE above, the optical disk is determined as having unauthorized copied data, and execution of an application is inhibited as a process to be performed on an unauthorized disk.

The second preferred embodiment performs the determination of the first preferred embodiment twice, thereby enhancing reliability of the determination.

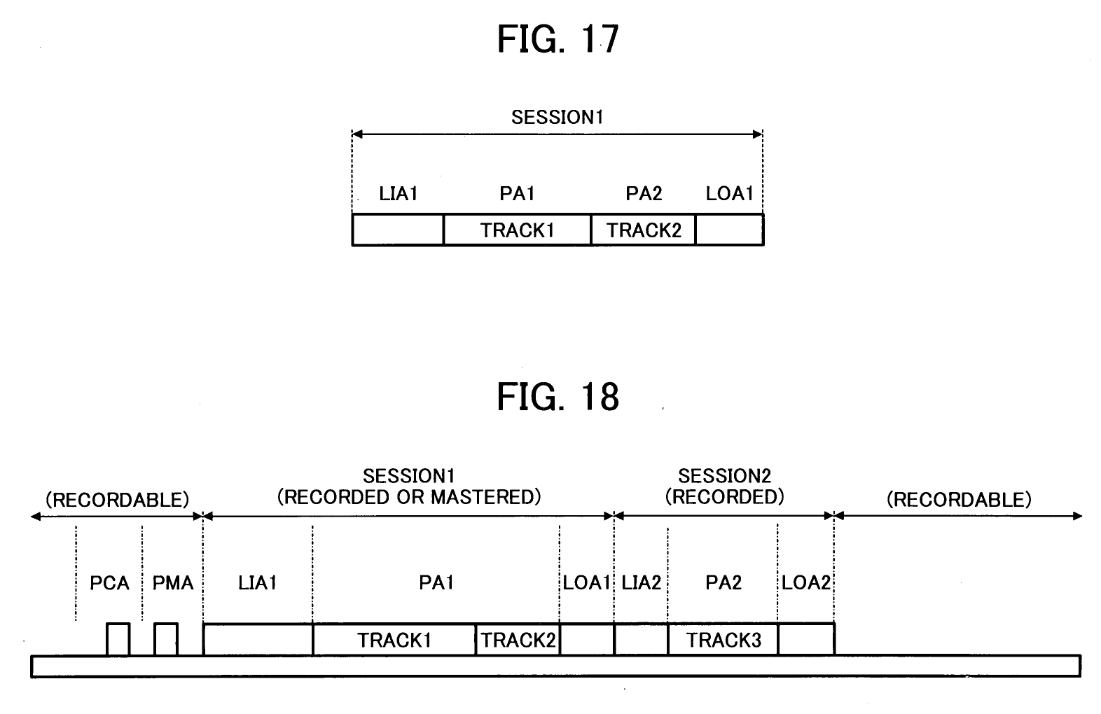

In an optical disk authentication process in a third preferred embodiment, the optical disk 4 includes a session1 having a track1 with data continuously recorded in a copy protective manner thereon, and a track2 with data continuously recorded in a copy protective manner thereon as shown in FIG. 17. The optical disk 4 stores a program for causing a computer to execute an authorized copy determination step based on the fact that the UDF track data is a predetermined value and is correct.

Since a single session is used in accordance with the third preferred embodiment, no overhead due to the recording of the lead-in and the lead-out occurs.

In an optical disk authentication process in accordance with a fourth preferred embodiment, the optical disk 4 is identical to the one of the third preferred embodiment except that the track2 has data recorded in a copy protection using VP.

In the VP copy-protected track2, the normal value of Ctrl2 is “5 (=0101),” and the normal value of TDU2 is “90 (=1001−0000).”

The optical disk is a hybrid one with data recorded with ROM pits.

The optical disk of the fourth preferred embodiment of the present invention has a track structure different from a standard CD-ROM (shown in FIG. 16), and presents difficulty in unauthorized copying in the DAO. With more determination means, the reliability of determination is enhanced.

An optical disk authentication process in accordance with a fifth embodiment (the different embodiment) of the present invention is explained below. The optical disk 4 contains repeated “FF” as authentication determination data in a user data field of a head packet in a track2 which contain data recorded in a copy-protected manner using VP. In this authentication process, it is assumed that the authentication process is performed relative to all the VP tracks.

In the authentication process illustrated in FIGS. 8 and 12-14, a part of the data acquisition step shown in FIG. 8 is commonly used by the first and second authentication processes. The data acquisition step in the second authentication process is explained FIGS. 8 and 12 and the authentication determination step is explained with reference to FIGS. 13 and 14.

The optical disk 4 has a session1 with a track1 that is continuously recorded in a copy protective manner as shown in FIG. 15. The track of the optical disk 4 has the structure (N=1) shown in FIG. 4. The optical disk 4 has at least two tracks with data recorded in a multi-session. At least one track other than the track1 of the session1 is recorded using the UDF. Data serving the authentication determination purpose is recorded in the UDF track.

An authorized copy determination module performs the authentication determination process including Steps S11-S15 of FIG. 8. In Step S11, the authorized copy determination module sets the track number to N. Step S12 is a start of a process loop and Step S15 is an end of the process loop, in which Steps S13 and S14 are repeated until a condition of Step S12, “I=(1 to N),” is fulfilled. In Step S13, start addresses (n, m) of user data of the track1 and track2, the lengths (x, y) of the user data, and controls (Ctrl1, Ctrl2) are acquired in response to a read TOC command. Then, in Step S14, TDU1 is acquired from a user data field of TDB residing at an address (n−8) or smaller and TDU2 is acquired from a user data field of TDB residing at an address (m−8) or smaller, in response to a read command. Also, block indicators RO11 and RO12 of RO blocks at addresses (n+x−2) and (n+x−1) in the track1 and block indicators RO21 and RO22 of RO blocks at addresses (m+y−2) and (m+y−1) in the track1 are acquired, in response to a read command.

Then, it is determined whether the track2 having data recorded in copy protection with VP, in which case Ctrl(2) is 5, is filled with the authentication determination data of repeated “FF,” for example.

In FIG. 12, a process loop is started with a condition that the variable I varies from 1 to N by Step S6 which is ended by Step S93 of FIG. 14 when I becomes N. Step S62 determines whether Ctrl(I) is 5, and subsequently Step S63 acquires VP data of VP(I). After that, Step S64 determines whether VP(I) is correctly acquired and Step S65 determines whether VP(2) is FF.

When VP(I) is determined as not being correctly acquired in Step S64 due to a command error, for example, “0” is entered into a variable J3(I) in Step S66. When VP(2) is determined as not being FF in Step S65, “−1” is entered into the variable J3(2) in Step S68. When VP(2) is determined as being FF, “1” is entered into the variable J3(2) in Step S67. The process proceeds to Step S71 of FIG. 13 when Ctrl(I) is determined as not being 5 in Step S62, or when J3(I) is set to “0” in Step S66, or when J3(2) is set to “1” in Step S67, or when J3(2) is set to “−1” in Step S68.

As described above, TDU1 and TDU2 are 80 (=1000-0000) and Ctrl1 is 4 (=0100) in the case of data tracks recorded continuously in the copy protection during the write mode, and TDU2 is 90 (=1001−0000) and Ctrl2 is 5 (=0101) in the case of data tracks recorded continuously in the copy protection using VP.

In FIG. 13, Step S71 determines whether TDU(I) is correctly acquired, and Step S72 determines whether values of TDU(I) and Ctrl(I) are correct. That is, during the process for the track1, Ctrl1 bit2 is checked to be equal to TDU1 bit7, Ctrl1 bit0 is checked to be equal to TDU1 bit5, and Ctrl1 is checked to be 5. When these values are satisfied, “1” (authentic) is obtained and is entered into a variable J11, in Step S74. When Ctrl1 bit2 is determined as not being equal to TDU1 bit7, or when Ctrl1 bit0 is determined as not being equal to TDU1 bit5, or when Ctrl1 is determined as not being 5, “−1” (false) is obtained and is entered into the variable J11 in Step S75. When the TDU1 is determined as not being correctly obtained due to a command error, for example, in Step S71, “0” is entered into the variable J11 in Step S73.

After that, during the subsequent process for the track2, Ctrl2 bit2 is checked to be equal to TDU2 bit7, Ctrl2 bit0 is checked to be equal to TDU2 bit5, and Ctrl2 is checked to be 5. When these values are satisfied, “1” (authentic) is obtained and is entered into a variable J12, in Step S74. When Ctrl2 bit2 is determined as not being equal to TDU2 bit7, or when Ctrl2 bit0 is determined as not being equal to TDU2 bit5, or when Ctrl2 is determined as not being 5, “−1” (false) is obtained and is entered into the variable J12 in Step S75. When the TDU2 is determined as not being correctly obtained due to a command error, for example, in Step S71, “0” is entered into the variable J12 in Step S73.

When one of J11 and J12 is “−1,” “−1” is entered into the variable J1. When both of the J11 and J12 are “1,” “1” is entered into the variable J1. In all other cases, “0” is entered into the variable J1.

Then, the process proceeds to Step S76 when “0” is entered into the variable J1 in Step S73, or when “1” is entered into the variable J1 in Step S74, or when “−1” is entered into the variable J1 in Step S75.

It should be noted that an authorized disk has “111” in both RO11 and RO12 and “110” in both RO21 and RO22. During the process for the track1, “−1” (false) is entered into the variable J2 when one of the RO11, RO12, RO21, and RO22 fails to agree with the respective values. When all of the RO11, RO21, RO12, and the RO22 agree with the respective values, “1” (authentic) is entered into the variable J2. In a case of a command error, “0” is entered into the variable J2.

More specifically, during the process for the track1, Step S76 determines whether RO is correctly acquired and Step S77 determines whether RO11 has an inequality with “111,” or whether RO21 has an inequality with “110.” Thus, when RO is correctly acquired in Step S76 and when RO11 is equal to 111 and RO21 is equal to 110 in Step S77, “1” (authentic) is acquired and is entered into a variable J21 in Step S79. When RO is correctly acquired in Step S76 and when RO11 is equal to 111 and RO21 is equal to 110 in Step S77, “−1” (false) is acquired and is entered into the variable J21 in Step S80. When Step S76 determines the case as a command error, “0” is entered into the variable J21 in Step S78.

After that, during the subsequent process for the track2, Step S76 determines whether RO is correctly acquired and Step S77 determines whether RO12 has an inequality with “111,” or whether RO22 has an inequality with “110.” Thus, when RO is correctly acquired in Step S76 and when RO12 is equal to 111 and RO22 is equal to 110 in Step S77, “1” (authentic) is acquired and is entered into a variable J21 in Step S79. When RO is correctly acquired in Step S76 and when RO11 is equal to 111 and RO21 is equal to 110 in Step S77, “−1” (false) is acquired and is entered into the variable J21 in Step S80. When Step S76 determines the case as a command error, “0” is entered into the variable J21 in Step S78.

When one of J21 and J22 is “−1,” “−1” is entered into the variable J2. When both of the J21 and J22 are “1,” “1” is entered into the variable J2. In all other cases, “0” is entered into the variable J2.

Then, the process proceeds to Step S91 of FIG. 14 when “0” is entered into the variable J2 in Step S78, or when “1” is entered into the variable J2 in Step S79, or when “−1” is entered into the variable J2 in Step S80.

The determination process is achieved by Steps S91-S99 of FIG. 14. That is, Step S91 determines the authenticity of the track(I) based on the resultant values of J1, J2, and J3, as described above. Step S92 determines whether any one of J1 (I), J2 (I), or J3 (I) is “−1.” When one of J1 (I), J2 (I) and J3(I) is “−1” in Step S92, “−1” is entered into a variable J in Step S99. When neither one of J1(I), J2(I), and J3(I) is “−1” in Step S92, a process loop of a determination Step 95 starting with Step S94 and ending with Step S96 is executed. Step S95 determines whether any one of J1(I), J2(I), and J3(I) is “1.” When one of J1(I), J2(I), and J3(I) is “1” in Step S95, “1” is entered into the variable J in Step S97. When neither one of J1(I), J2(I), and J3(I) is “1” in Step S95, “0” is entered into the variable J in Step S98.

In response to an authorized copy determination command from an application program, the authorized copy determination module performs steps of FIGS. 8 and 12-14, and provides J1, J2 and J3 as return values. The application program authenticates the optical disk referring to the return values, and determines a subsequent process depending on security level required.

It is difficult to set all data to “FF” in a head packet in the optical disk having data recorded using a packet write software program. The fifth preferred embodiment of the present invention thus prevents the packet write software program from using unauthorized copied data.

In accordance with the fifth preferred embodiment of the present invention, the repetition of “FF” is used as authentication criterion data. A repetition of any character string of two byte codes may be used.

The value of the authentication criterion data may be recorded as a constant on the authorized copy determination module. Alternatively, the value of the authentication criterion data may be input in a file or using a keyboard.

Depending on PC environments or drives, the commands may be in error or the commands may be blocked on software programs.

In the first through fifth preferred embodiments of the present invention, the return value in the case of the command error is set to be “0”. Alternatively the return value may be set to be “−1” depending on security level.

In an optical disk authentication determination process of an optical disk in accordance with the sixth preferred embodiment of the present invention, the optical disk 4 has a disk layout shown in FIG. 18.

As shown, the optical disk 4 includes a session 1 and a session 2. The session 1 is a read-only memory area, and the session 2 is a random-access memory area. The session 1 contains a track 1 having a program of the six preferred embodiment of the present invention recorded thereon and a track 2 (a dummy track) not present in the ISO 9660 file system.

Each session includes a lead-in area (LIA), a program area (PA), and a lead-out area (LIA). The PA includes at least one track.

Recorded on the TOC of the LIA of each track are a control (CT) and ADR representing the recording method of the track of each session, and time information representing a recording position (ST) of the track. The same information is also recorded in a program memory area (PMA) at an inner circle of the LIA in the session 1.

The process of the optical disk system in accordance with the present invention is now described.

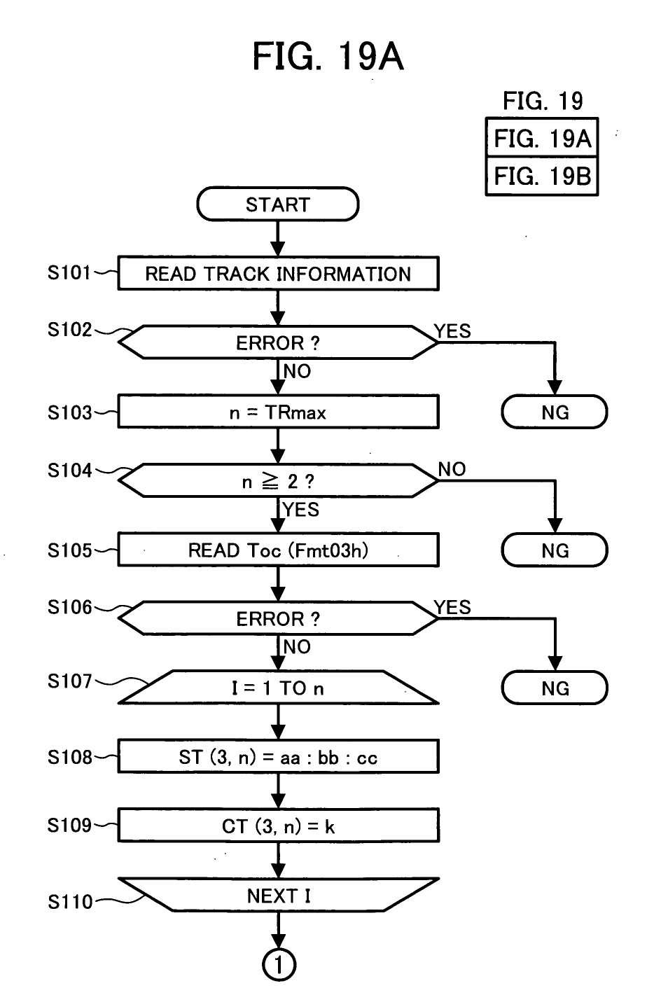

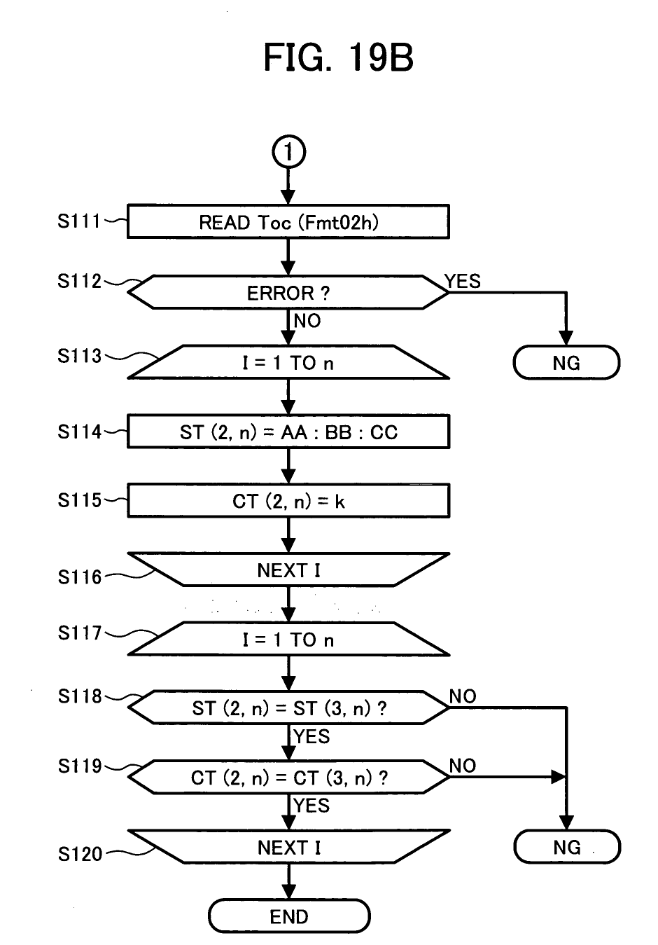

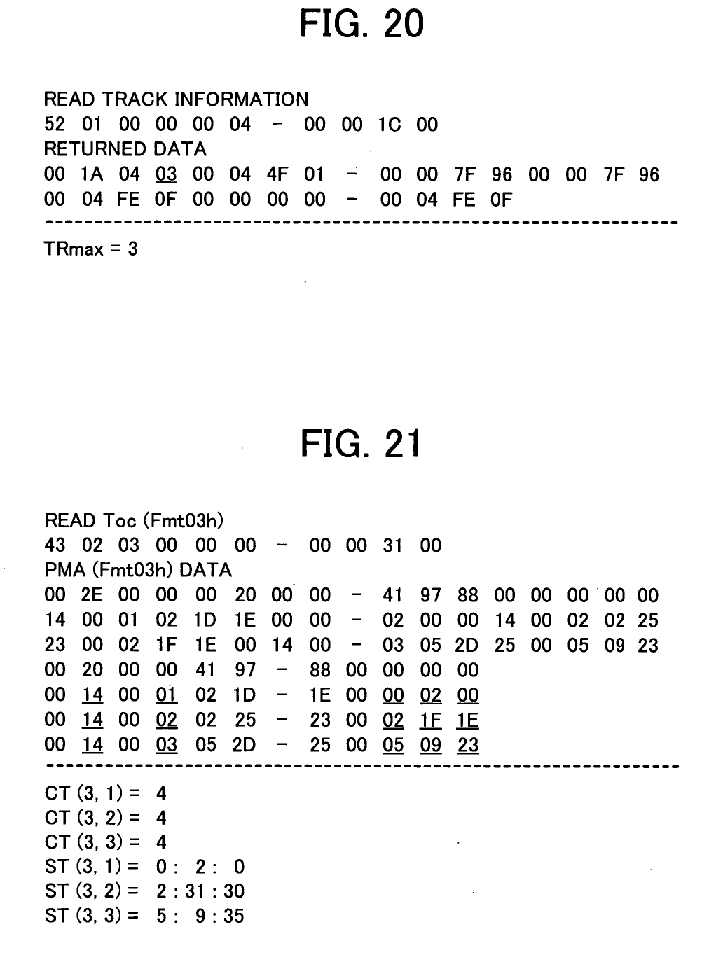

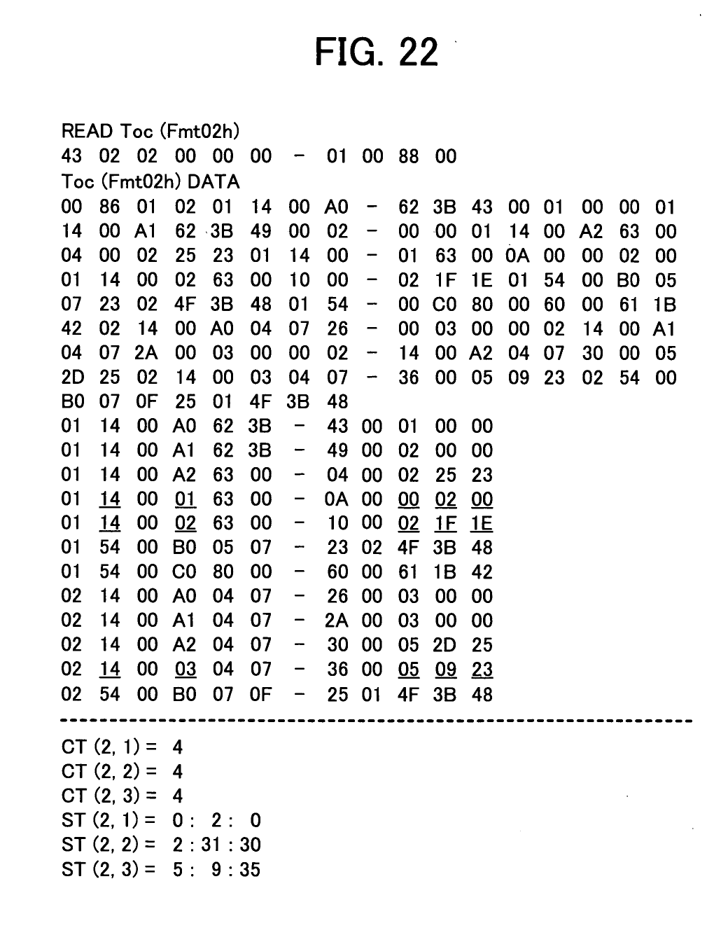

FIG. 19 is a flowchart of an optical disk authentication process of an optical disk shown in FIG. 18.

An authorized copy determination module for executing an authorized copy determination process performs steps S101-S120.

In steps S101-S102, a maximum number of tracks (TRmax) is acquired in response to a read disk information command.

In steps S105-S110, track information (CT and ST) of the PMA is acquired in response to a read TOC (Fmt 03) command.

In steps S111-S116, track information (CT and ST) of the TOC is acquired in response to a read TOC (Fmt 02) command.

In steps S117-S120, track information of the PMA is compared with track information of the TOC.

The track 2 (dummy track) non-existent in the ISO 9660 file system cannot be copied in the TAO (track at once), and the PMA cannot be copied in the DAO. With the authentication determination method for authenticating the recording medium, the computer program for the authentication determination method, and the computer readable recording medium, the data that has been illegally copied onto the recording medium such as an optical disk is prevented from being used.

In the disks of the preferred embodiments of the present invention, the TAO track is formed as the track 2. Alternatively, a VP (variable packet) track may be formed as the track 2. In this arrangement, the formation of the track 2 becomes even more difficult through a copying operation.

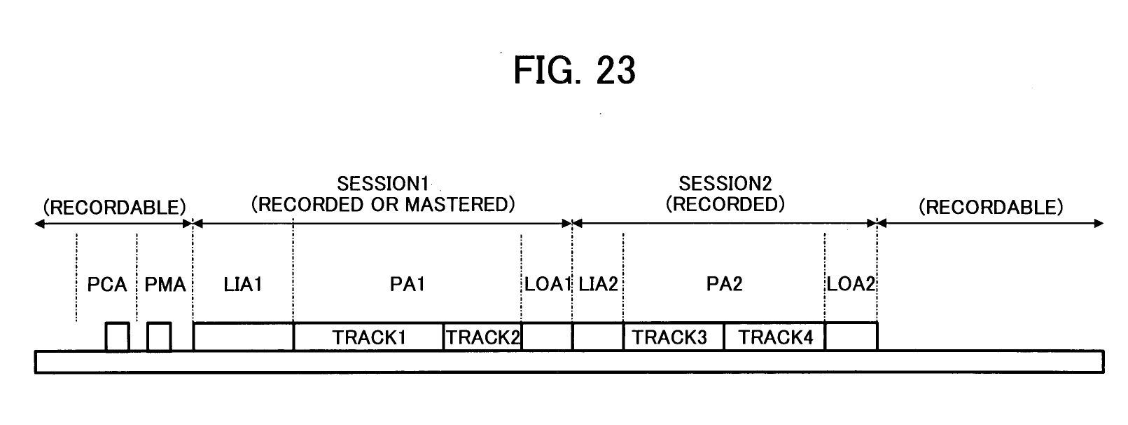

In an optical disk authentication process in accordance with a seventh preferred embodiment of the present invention, the optical disk 4 has a disk layout as shown in FIG. 23.

As shown, the optical disk 4 includes a session 1 and a session 2. The session 1 is a read-only memory area, and the session 2 is a random-access memory area.

Each session includes a lead-in area (LIA), a program area (PA), and a lead-out area (LIA). The PA includes two tracks.

Since the file system typically recognizes the first track only in each session, a known multi-session optical disk is recorded in a format with one track per session as shown in FIG. 16B.

The optical disk of the seventh preferred embodiment of the present invention includes tracks 1 and 3 where data recording is performed in a track at once method, and tracks 2 and 4 where data recording is performed in a packet write method.

Information of the two tracks of the session 1 is recorded onto the PMA in a read-only memory method. Information of the two tracks of the session 2 is written together with a disk ID by the drive during an additional recording of the session 2.

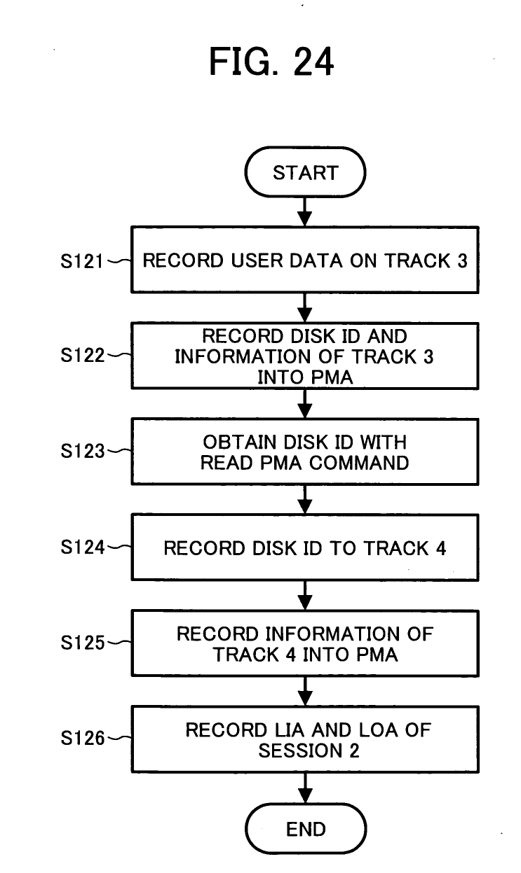

FIG. 24 illustrates the operation of a recording software program that functions to additionally record the user data onto the session 2 of the optical disk 4.

In step S121, the user data is recorded onto the track 3. In step S122, the disk ID and the information of the track 3 are recorded. In step S123, the disk ID is acquired in response to a read PMA command. In step S124, the disk ID is recorded onto the track 4. In step S125, the information of the track 4 is recorded onto the PMA. In step S126, the LIA and LOA of the session 2 are recorded.

Data such as “FF” is recorded in the track 2 as data unique to a stamper. The recording software program acquired in response to the read PMA command records, as data unique to each disk, the disk ID that is attached to each disk in a random fashion during recording. Since the disk ID is randomly attached to each disk by the drive during recording, copying the disk ID is difficult.

In the authentication determination process, the data of the second track is acquired in response to a read CD command. If the data is not “FF”, the optical disk 4 is determined as being an unauthorized disk. The disk ID is acquired from the PMA in response to a read PMA command, and the data of the track 4 is acquired in response to a read CD command. If the disk ID acquired from the PMA and the data of the track 4 fail to agree, the optical disk 4 is determined as being an unauthorized disk.

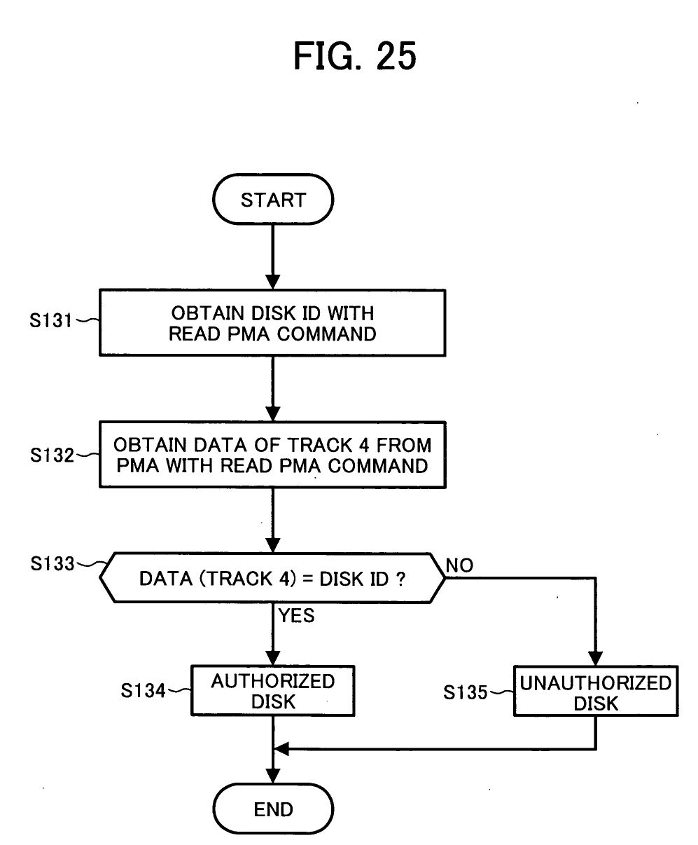

FIG. 25 is a flowchart illustrating the optical disk authentication process of the optical disk 4 illustrated in FIG. 23.

In the authorized copy determination process, the disk ID is acquired in response to a read PMA command in step S131. In step S132, the data of the track 4 is acquired from the PMA in response to a read CD command. In step S133, it is determined whether the data of the track 4 agrees with the disk ID. If it is determined that the data of the track 4 agrees with the disk ID, the process proceeds to step S134. The optical disk is thus determined as being an authentic optical disk or an optical disk the use of which is authorized. If it is determined that the data of the track 4 fails to agree with the disk ID, the process proceeds to step S135. The optical disk is thus determined as being a false optical disk or an illegally copied disk.

Depending on PC environments or drives, the commands may be in error or the commands may be blocked on software programs. The command error may be determined as being “false” depending on security level.

In the above-referenced preferred embodiments of the present invention, an application software program is stored in the optical disk together with the authorized copy determination means. The application software program may be stored in the hard disk drive or a network server.

In the optical disk 4 in accordance with the first through seventh preferred embodiments of the present invention, the application software program may be recorded onto the CD-R(RW) using a write software program. Alternatively, a disk having the application software program recorded beforehand thereon is coated with a colorant layer, as a recording layer, a reflective layer, and a protective layer. This arrangement substantially heightens manufacturing yield of the disks.

The authentication determination method of the recording medium, the computer program, and the computer readable recording medium in accordance with the preferred embodiments of the present invention are applicable to personal computers such as a desktop personal computer, or a notebook personal computer.

Numerous additional modifications and variations are possible in light of the above teachings. It is therefore to be understood that within the scope of the appended claims, the disclosure of this patent specification may be practiced otherwise than as specifically described herein.

What is claimed is:

1. A method for authenticating a recording medium, the method comprising the steps of:
acquiring, from the recording medium, unique data that is recorded on an information track on the recording medium in accordance with a predetermined rule; and
authenticating the recording medium based on the unique data acquired in the data acquisition step.

2. A method according to claim 1, wherein the predetermined rule is based on a plurality of types of recording methods.

3. A method according to claim 2, wherein the plurality of types of recording methods comprises an uninterrupted recording method and an incremental recording method.

4. A method according to claim 3, wherein the uninterrupted recording method is a track at once recording method, and the incremental recording method is a packet write recording method.

5. A method according to claim 1, wherein the unique data comprises information for identifying the recording method.

6. A method according to claim 1, wherein the unique data comprises at least one of data in a track descriptor unit and data in a sub-code control.

7. A method according to claim 1, wherein the unique data comprises data within a runout.

8. A method according to claim 1, wherein the unique data comprises data within a predetermined packet.

9. A method according to claim 1, wherein the unique data comprises data that is recorded in multiple sessions.

10. A method according to claim 1, wherein the unique data comprises data that is recorded in a variable packet.

11. A method for authenticating a recording medium, the method comprising the steps of:
acquiring, from the recording medium, unique data that is recorded in a variable packet on an information track on the recording medium in accordance with a predetermined rule; and
authenticating the recording medium based on the unique data acquired in the data acquisition step.

12. A method according to claim 11, wherein the recording medium has, in a first session, a second track as a dummy track not present in the ISO 9660 file system and wherein the information track comprises an LIA (lead in area) and a PMA (program memory area).

13. A method according to claim 12, wherein the unique data comprises track information.

14. A method according to claim 13, wherein the track information identifies a recording method of the track.

15. A method according to claim 13, wherein the track information identifies a recording position of the track.

16. A method according to claim 12, wherein the recording medium records data in multiple sessions.

17. A method according to claim 16, wherein the information track comprises a PMA and a second track that is additionally recorded.

18. A method according to claim 17, wherein the unique data of the second track that is additionally recorded comprises a disk ID.

19. A computer program for causing a computer to perform an instruction for authenticating a recording medium, the instruction comprising the steps of:
acquiring, from the recording medium, unique data that is recorded on an information track on the recording medium in accordance with a predetermined rule; and
authenticating the recording medium based on the unique data acquired in the data acquisition step.

20. A computer readable recording medium storing a computer program for causing a computer to perform an instruction for authenticating a recording medium, the instruction comprising the steps of:
acquiring, from the recording medium, unique data that is recorded on an information track on the recording medium in accordance with a predetermined rule; and
authenticating the recording medium based on the unique data acquired in the data acquisition step.

21. A computer readable recording medium comprising a read-only memory area and a read and write memory area, and storing, on the read and write area, a computer program for causing a computer to perform an instruction for authenticating a recording medium, the instruction comprising the steps of:
acquiring, from the recording medium, unique data that is recorded on an information track on the recording medium in accordance with a predetermined rule; and
authenticating the recording medium based on the unique data acquired in the data acquisition step.

22. An optical disk drive system, comprising:
a memory storing a program; and
a processor configured to execute the program stored in the memory,
wherein the program includes an instruction for authenticating a recording medium, the instruction comprising the steps of:
acquiring, from the recording medium, unique data that is recorded on an information track on the recording medium in accordance with a predetermined rule; and
authenticating the recording medium based on the unique data acquired in the data acquisition step.
